(19) United States
(12) Patent Application Publication
(10) Pub. No.: US 2020/0296443 A1
(43) Pub. Date: Sep. 17, 2020

(54) TRANSMISSION DEVICE, RECEPTION DEVICE, AND VIDEO DISTRIBUTION METHOD

(71) Applicant: NEC Corporation, Tokyo (JP)

(72) Inventor: Natsuki KAI, Tokyo (JP)

(73) Assignee: NEC Corporation, Tokyo (JP)

(21) Appl. No.: 16/756,026

(22) PCT Filed: Oct. 23, 2018
(86) PCT No.: PCT/JP2018/039254

§ 371 Date: Apr. 14, 2020

(30) Foreign Application Priority Data
Oct. 25, 2017 (JP) 2017-206266

(51) Int. Cl. H04N 21/2662; H04N 21/845; H04N 19/463; H04N 19/172; H04N 21/442

(52) U.S. Cl. CPC H04N 21/2662; H04N 21/8455; H04N 21/44209; H04N 19/463; H04N 19/172; H04N 21/8456

(57) ABSTRACT

To provide a reception device capable of precisely estimating throughput on the basis of a breakpoint between video frames in a communication system where video-frame-based transmission is intermittently performed. A reception device is configured to be provided with a reception means, a breakpoint position estimation means, and a transmission means. The reception means receives packets obtained by dividing a video frame. The breakpoint position estimation means estimates a packet which is a breakpoint between video frames on the basis of packet information about the packets received by the reception means. The transmission means transmits, to a transmission device of the packets, information about the reception time of the video frame and information about the data size thereof on the basis of the estimation result of the breakpoint.

### TECHNICAL FIELD

The present invention relates to a video distribution technique, and more particularly, to a technique of estimating throughput during video distribution.

### BACKGROUND ART

High-definition real-time video transmission via a best-effort communication network in which throughput drastically changes, such as a wireless communication network for a mobile phone and a wireless local area network (LAN), has been widely performed. Further, as a video data reception function, a video management system (VMS) has been widely employed. The VMS is employed, for example, in a security support system and the like in which videos received from a plurality of monitoring cameras and the like are collected, and based on an analysis result of the collected videos.

In order to perform high-definition real-time video transmission, an adaptive video distribution control technique (quality of service (QoS) control technique) of dynamically changing a compression encoding parameter of video according to throughput that changes becomes necessary. In view of the above, in a communication network in which throughput dynamically changes, development of a technique in which throughput information is acquired, and a communication parameter is determined, based on the acquired throughput has been carried out. As such a technique of determining a communication parameter, based on throughput, a technique such as PTL 1 is disclosed.

PTL 1 relates to a video quality estimation device that calculates a reception rate of a packet of video data in a relay device or a reception terminal, and determines an encoding bit rate. The video quality estimation device in PTL 1 determines the encoding bit rate, based on the reception rate of the packet in the relay device or the reception terminal, and estimates experience quality of a user, based on the encoding bit rate.

PTL 2 describes a reception device that estimates a transmission bit rate of video data, and transmits information on a video frame rate associated with the transmission bit rate to a transmission device. The reception device in PTL 2 measures transmission quality, when receiving video data from the transmission device, and estimates an estimated bit rate, taking into consideration an influence on transmission, based on a bit rate calculated from the measurement result. Further, the reception device in PTL 2 transmits, to the transmission device, a video frame rate associated with the estimated bit rate.

### CITATION LIST

### Patent Literature

[PTL 1] Japanese Unexamined Patent Application Publication No. 2011-130176
[PTL 2] Japanese Unexamined Patent Application Publication No 2012-244566

### SUMMARY OF INVENTION

### Technical Problem

However, the technique of PTL 1 is not sufficient in the following points. In video distribution employing QoS control, it is necessary that a transmission side and a reception side operate in cooperation with each other in order to set an appropriate compression encoding parameter. However, the VMS does not have a function of acquiring information necessary for estimating throughput such as a breakpoint of a video frame. Further, in many cases, it is difficult to add, to the VMS being a large-scale system, a function of acquiring information necessary for estimating throughput. Therefore, a device on the reception side is required to separately have a function of acquiring information necessary for estimating throughput, and feeding back the information to the transmission side. However, since the video quality estimation device in PTL 1 cannot precisely detect a breakpoint position between video frames, it is not possible to enhance estimation precision of throughput in a video frame unit. Therefore, in a communication system in which transmission is intermittently performed in a video frame unit, the technique of PTL 1 is not sufficient as a technique of estimating throughput.

The reception device in PTL 2 calculates a bit rate by measuring transmission quality. Therefore, similarly to PTL 1, the reception device in PTL 2 cannot precisely detect a breakpoint position between video frames, and cannot enhance estimation precision of throughput in a video frame unit. Thus, the technique of PTL 2 is not sufficient as a technique of estimating throughput in a communication system in which transmission is intermittently performed in a video frame unit.

In order to solve the above-described issues, an object of the present invention is to provide a reception device, a transmission device, and a video distribution method that are capable of precisely estimating throughput, based on a breakpoint of a video frame, when transmission is intermittently performed in a video frame unit.

### Solution to Problem

In order to solve the above-described issues, a reception device according to the present invention includes: a reception means, a breakpoint position estimation means, and a transmission means. The reception means receives a packet acquired by dividing a video frame. The breakpoint position estimation means estimates, based on packet information on the packet received by the reception means, a packet being a breakpoint between the video frames. The transmission means transmits, to a transmission device of the packet, information relating to a reception duration of the video frame and information on a data size, based on a result of estimation of a breakpoint position.

A transmission device according to the present invention includes a reception means, a throughput measurement means, a parameter determination means, a compression encoding means, and a transmission means. The reception means receives, from a reception device, information on a time required for receiving a video frame and a data size of the video frame in the reception device being a transmission destination of the video frame. The throughput measurement means calculates transmission and reception throughput of the video frame, as statistical data, based on information relating to a time required for receiving the video frame and a data size of the video frame in the reception device. The parameter determination means determines, based on the statistical data of the throughput, a parameter when the video frame to be transmitted to the reception device is compression-encoded. The compression encoding means applies compression encoding to the video frame, based on the parameter determined by the parameter determination means. The transmission means transmits, to the reception device, a packet based on data of the video frame to which compression encoding is applied by the compression encoding means.

A video distribution method according to the present invention receives a packet acquired by dividing a video frame. The video distribution method according to the present invention estimates, based on packet information on the received packet, a packet being a breakpoint between the video frames. The video distribution method according to the present invention transmits, to a transmission device of the packet, information relating to a reception duration of the video frame of which a breakpoint position is estimated and information on a data size.

### Advantageous Effects of Invention

The present invention enables precisely estimating throughput, based on a breakpoint of a video frame, when transmission is intermittently performed in a video frame unit.

### BRIEF DESCRIPTION OF DRAWINGS

FIG. 1 is a diagram illustrating an overview of a configuration of a transmission device according to a first exam embodiment of the present invention.

FIG. 2 is a diagram illustrating an overview of a configuration of a reception device according to the first example embodiment of the present invention.

FIG. 3 is a diagram illustrating an overview of a configuration of a video distribution system according to the first example embodiment of the present invention.

FIG. 4 is a diagram illustrating an overview of a configuration according to a second example embodiment of the present invention.

FIG. 5 is a diagram illustrating an overview of a configuration of a transmission device according to the second example embodiment of the present invention,

FIG. 6 is a diagram illustrating an overview of a configuration of a reception device according to the second example embodiment of the present invention.

FIG. 7 is a diagram illustrating an operation flow of the transmission device according to the second example embodiment.

FIG. 8 is a diagram illustrating an operation flow of the reception device according to the second example embodiment.

FIG. 9 is a diagram illustrating an example of a timewise change of throughput according to the second example embodiment of the present invention.

FIG. 10 is a diagram schematically illustrating packets acquired by dividing a video frame according to the second example embodiment of the present invention.

FIG. 11 is a diagram illustrating an example of a measurement result of a reception interval during burst transmission according to the second example embodiment of the present invention.

FIG. 12 is a diagram illustrating an example of data in which a reception time and a data size of a packet are recorded according to the second example embodiment of the present invention.

FIG. 13 is a diagram illustrating an example of a measurement result of a reception interval of packets according to the second example embodiment of the present invention.

FIG. 14 is a diagram illustrating a specific configuration example of a video distribution system according to the second example embodiment of the present invention.

### EXAMPLE EMBODIMENT

### First Example Embodiment

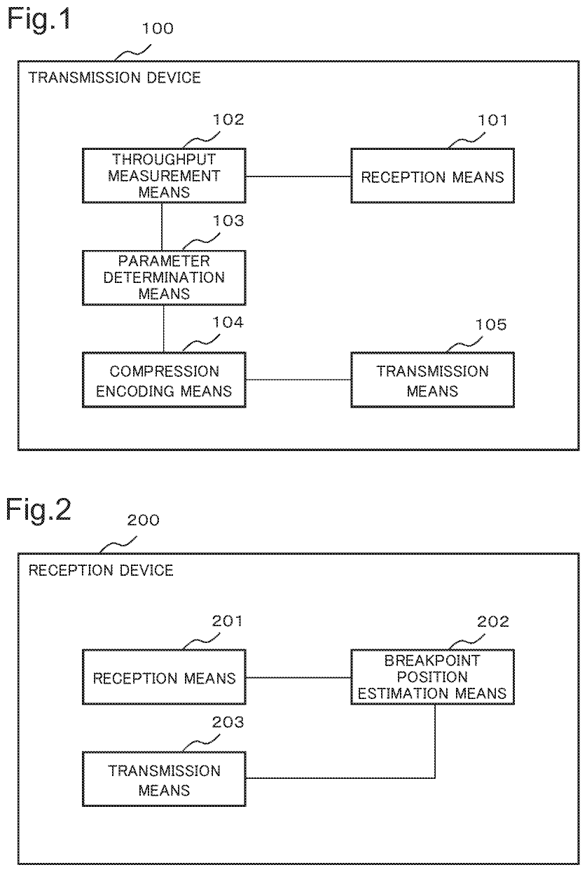

A first example embodiment according to the present invention is described in detail with reference to the drawings, FIG. 1 illustrates an overview of a configuration of a transmission device 100 according to the present example embodiment. FIG. 2 illustrates an overview of a configuration of a reception device 200 according to the present example embodiment.

A configuration of the transmission device 100 according to the present example embodiment is described with reference to FIG. 1. The transmission device 100 according to the present example embodiment includes a reception means 101, a throughput measurement means 102, a parameter determination means 103, a compression encoding means 104, and a transmission means 105. The reception means 101 receives, from a reception device, information on a time required for receiving a video frame and a data size of the video frame in the reception device being a transmission destination of the video frame. The throughput measurement means 102 calculates transmission and reception throughput of the video frame, as statistical data, based on the information relating to the time required for receiving the video frame and the data size of the video frame in the reception device. The parameter determination means 103 determines, based on the statistical data of the throughput, a parameter when the video frame to be transmitted to the reception device is compression-encoded. The compression encoding means 104 applies compression encoding to the video frame, based on the parameter determined by the parameter determination means 103. The transmission means 105 transmits, to the reception device, a packet based on data of the video frame to which compression encoding is applied by the compression encoding means 104.

The transmission device 100 according to the present example embodiment calculates, in the throughput measurement means 102, transmission and reception throughput of a video frame, as statistical data, based on a time required for receiving the video frame and a data size of the video frame in a reception device. Further, the transmission device 100 according to the present example embodiment determines, in the parameter determination means 103, a parameter for use in compression encoding the video frame, based on the throughput, and transmits, in the compression encoding means 104, the video frame, based on the determined parameter by compression encoding the video frame. Since the transmission device 100 according to the present example embodiment determines a compression encoding parameter, based on throughput in a video frame unit, it is possible to precisely estimate throughput even in a communication system in which transmission is intermittently performed in a video frame unit.

A configuration of the reception device 200 according to the present example embodiment is described with reference to FIG. 2. The reception device 200 according to the present example embodiment includes a reception means 201, a breakpoint position estimation means 202, and a transmission means 203. The reception means 201 receives a packet acquired by dividing a video frame. The breakpoint position estimation means 202 estimates a packet being a breakpoint between video frames, based on packet information on the packet received by the reception means 201. The transmission means 203 transmits, to a transmission device of the packet, information relating to a reception duration of the video frame and information on a data size, based on a result of estimation of a breakpoint position.

The reception device 200 according to the present example embodiment estimates, in the breakpoint position estimation means 202 packet being a breakpoint between video frames, based on packet information on the packet received by the reception means 201. Further, the reception device 200 according to the present example embodiment transmits, in the transmission means 203, information relating to a reception duration of the video frame of which a breakpoint position is estimated and information on a data size, to a transmission device of the packet. Therefore, employing the reception device 200 according to the present example embodiment enables to calculate throughput in a video frame unit, based on information relating to a reception duration of a video frame and information on a data size. Consequently, employing the reception device 200 according to the present example embodiment enables to precisely estimate throughput, based on a breakpoint of a video frame, even in a communication system in which transmission is intermittently performed in a video frame unit.

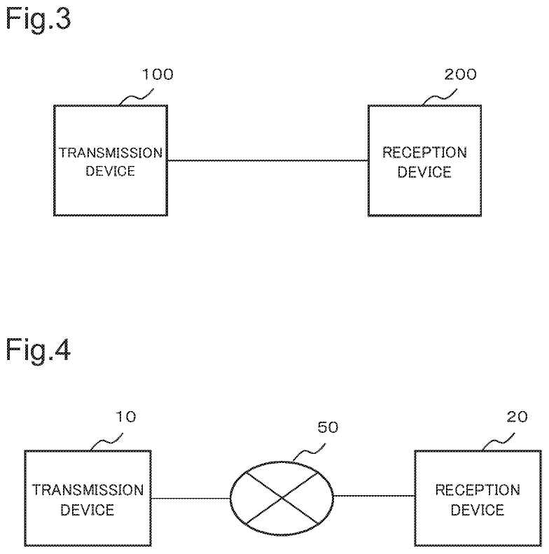

Employing the transmission device 100 and the reception device 200 according to the present example embodiment enables to configure a video distribution system as illustrated in FIG. 3. FIG. 3 illustrates an overview of a configuration of the video distribution system in which the transmission device 100 and the reception device 200 are employed.

In a configuration as illustrated in FIG. 3, the reception device 200 receives, from the transmission device 100, a packet based on a video frame via a communication network. The breakpoint position estimation means 202 of the reception device 200 estimates, based on packet information on the packet received from the transmission device 100, a packet being a breakpoint between video frames. The throughput measurement means 102 of the transmission device 100 calculates, based on a time required for receiving a video frame to be received from the reception device 200 and a data size of the video frame, transmission and reception throughput of the video frame, as statistical data.

In this way, by causing the reception device 200 to estimate a packet being a breakpoint between video frames, and transmitting, to the transmission device 100, a time required for receiving a video frame and a data size of the video frame, it is possible to precisely estimate transmission throughput of the video frame.

### Second Example Embodiment

A second example embodiment according to the present invention is described in detail with reference to the drawings. FIG. 4 illustrates an overview of a configuration of a video distribution system according to the present example embodiment. The video distribution system according to the present example embodiment includes a transmission device 10 and a reception device 20. The transmission device 10 and the reception device 20 are connected via a communication network 50.

The video distribution system according to the present example embodiment is a system in which a video frame is transmitted from the transmission device 10 to the reception device 20 via the communication network 50 by compression encoding in live video distribution and the like in the video distribution system according to the present example embodiment, compression encoding is applied to a video frame that is captured on a real-time basis, and the video frame to which compression encoding is completed is intermittently transmitted in a video frame unit.

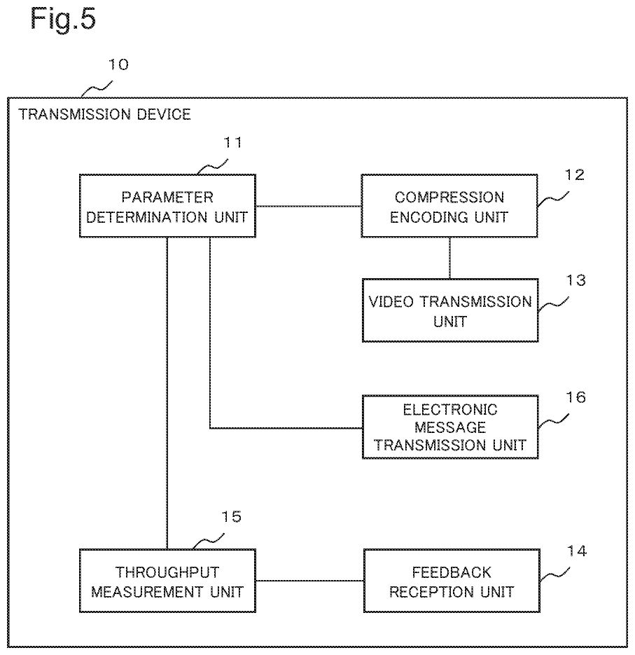

A configuration of the transmission device 10 according to the present example embodiment is described. FIG. 5 illustrates an overview of a configuration of the transmission device 10 according to the present example embodiment. The transmission device 10 includes a parameter determination unit 11, a compression encoding unit 12, a video transmission unit 13, a feedback reception unit 14, a throughput measurement unit 15, and an electronic message transmission unit 16.

The parameter determination unit 11 has a function of determining a parameter for use in compression encoding data of a video frame. The parameter determination unit 11 determines a frame rate of a compression-encoded video frame, as a parameter for use in compression encoding. The parameter determination unit 11 transmits information on the determined frame rate to the compression encoding unit 12 and the electronic message transmission unit 16.

The compression encoding unit 12 has a function of compression encoding data of a video frame. The compression encoding unit 12 compression-encodes data of a video frame, based on frame rate information to be input from the parameter determination unit 11, as a parameter when compression encoding is performed. The compression encoding unit 12 transmits, to the video transmission unit 13, a compression-encoded video frame.

The video transmission unit 13 divides data of the compression-encoded video frame into packets, and transmits the packets to the reception device 20 via the communication network 50. The video transmission unit 13 transmits packets acquired by dividing a video frame, each time compression encoding of data of the video frame is completed. Specifically, in the case that compression encoding of a next video frame is not completed, when transmission of data of one video frame of which compression is completed is completed, transmission of packets generated based on a video frame is not performed.

The feedback reception unit 14 has a function of receiving, as feedback information, information necessary in estimating throughput. The feedback reception unit 14 receives the feedback information from the reception device 20 via the communication network 50. The feedback reception unit 14 receives, from the reception device 20, information on a reception start time of a video frame, a reception completion time of the video frame, and a data size of the video frame in the reception device 20, as the feedback information. Specifically, the feedback information is constituted based on information on a time required for receiving a video frame, which is indicated by a reception start time of the video frame and a reception completion time of the video frame, and information on a data size of the video frame. The feedback reception unit 14 transmits, to the throughput measurement unit 15, the feedback information received from the reception device 20.

The throughput measurement unit 15 has a function of calculating throughput, when a video frame is transmitted based on the feedback information. The throughput measurement unit 15 calculates throughput from a reception start time, a reception completion time, and a data size for each video frame to be received as the feedback information. The throughput measurement unit 15 calculates the throughput, as a statistical amount.

The electronic message transmission unit 16 has a function of transmitting frame rate information to the reception device 20, The electronic message transmission unit 16 transmits, to the reception device 20 via the communication network 50, frame rate information to be received from the parameter determination unit 11.

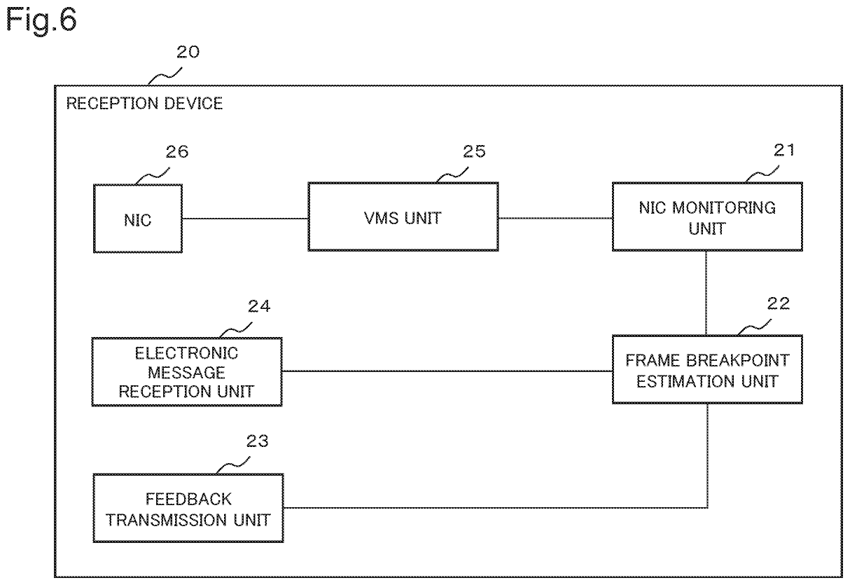

A configuration of the reception device 20 according to the present example embodiment is described. FIG. 6 illustrates an overview of the configuration of the reception device 20 according to the present example embodiment. The reception device 20 includes a network interface card (NIC) monitoring unit 21, a frame breakpoint estimation unit 22, a feedback transmission unit 23, an electronic message reception unit 24, a video management system (VMS) unit 25, and an NIC 26.

The NIC monitoring unit has a function of monitoring a packet to be received by the NIC 26. The NIC monitoring unit 21 detects a packet of a video frame by monitoring the packet to be received by the NIC 26. The NIC monitoring unit 21 acquires packet information from the packet to be received by the NIC 26. The packet information is information on a reception time of a packet, a type of a transport protocol, a transmission source IP address, a transmission source port number, a transmission destination IP address, a transmission destination port number, a payload size, and the like. The NIC monitoring unit 21 determines a packet of a video frame by performing filtering, based on a transmission source IP address and a transmission destination port number.

The frame breakpoint estimation unit 22 has a function of determining a packet being a breakpoint of a video frame. A method for determining a packet being a breakpoint of a video frame by the frame breakpoint estimation uni t 22 is described later.

The feedback transmission unit 23 transmits, to the transmission device 10, information on a reception start time, a reception time, and a data size of a video frame, as feedback information. The feedback transmission unit 23 determines, based on packet information on a packet at a breakpoint position of a video frame, and a sum value of data sizes of packets received between two breakpoint positions, the reception start time, the reception time, and the data size of the video frame.

The electronic message reception unit 24 has a function of receiving frame rate information of a compression-encoded video frame, as a compression encoding parameter. The electronic message reception unit 24 receives, from the transmission device 10 via the communication network 50, frame rate information when a video frame is compression-encoded. The electronic message reception unit 24 transmits, to the frame breakpoint estimation unit 22, frame rate information when a received video frame is compression-encoded.

The VMS unit 25 performs processing such as decoding a compression-encoded video frame, and outputs data of the video frame to a display device and the like.

The NIC 26 is a communication module for performing transmission and reception of data to and from the transmission device 10 and another communication device via the communication network 50.

The communication network 50 is a communication network having a heterogeneous configuration by combination of the Internet, a mobile network, and the like.

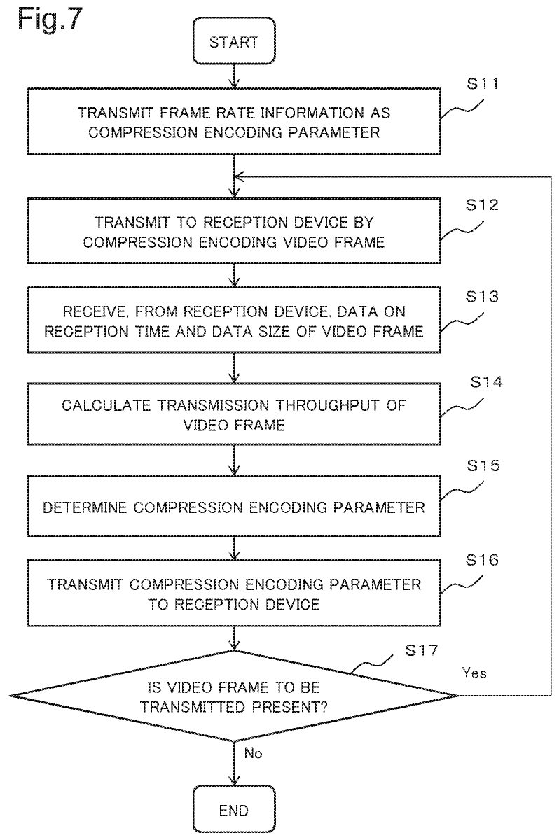

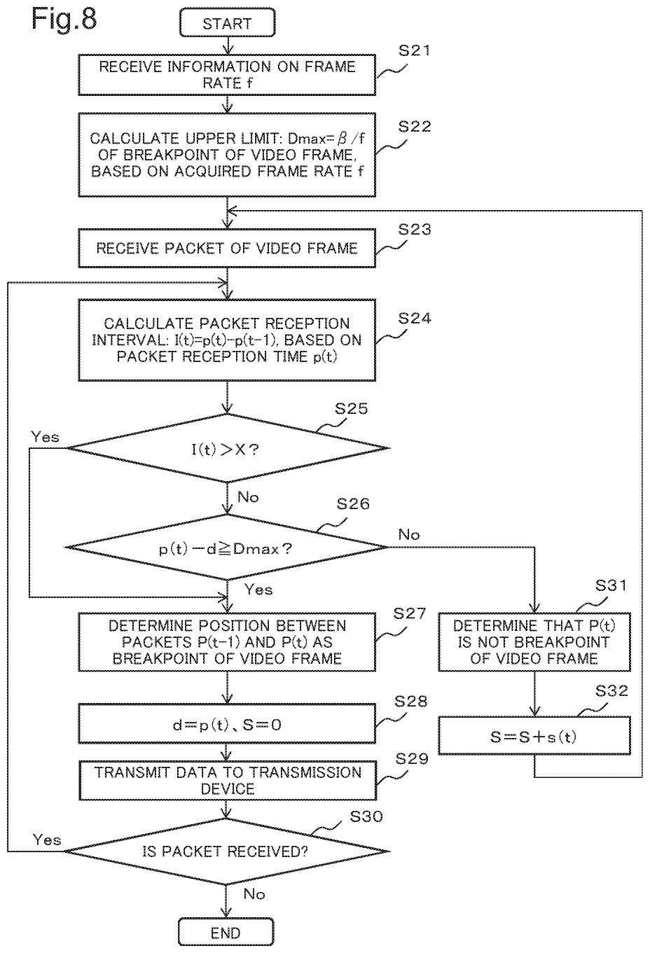

An operation of the video distribution system according to the present example embodiment is described. FIG. 7 illustrates an overview of an operation flow of the transmission device 10 according to the present example embodiment. FIG. 8 illustrates an overview of an operation flow of the reception device 20 according to the present example embodiment.

When a video frame is input to the transmission device 10 as video data for distribution, the transmission device 10 starts an operation of transmitting the video frame to the reception device 20 by performing compression encoding.

The parameter determination unit 11 of the transmission device 10 transmits, to the compression encoding unit 12 and the electronic message transmission unit 16, frame rate information as a parameter for use in compression encoding the video frame to be transmitted to the reception device 20. As a frame rate immediately after start of the operation, a predetermined value or a value that has been used when video data have been transmitted to the reception device 20 before.

After receiving the frame rate information as information on a compression encoding parameter, the electronic message transmission device 16 transmits the frame rate information to the reception device 20 via the communication network 50 (Step S11).

When data of a video frame to be transmitted to the reception device 20 are input, the compression encoding unit 12 compression-encodes the video frame, based on a frame rate to be input from the parameter determination unit 11.

When the video frame is compression-encoded, the compression encoding unit 12 transmits, to the video transmission unit 13, data of the compression-encoded video frame. After receiving the video frame data, the video transmission unit 13 generates a packet for transmission, based on the video frame data. When the packet for transmission is generated, the video transmission unit 13 transmits the generated packet to the communication network 50. The packet transmitted from the transmission device 10 is transmitted to the reception device 20 via the communication network 50.

When the frame rate information is transmitted to the reception device 20, the electronic message reception unit 24 of the reception device 20 receives the frame rate information (Step S21). After receiving the frame rate information, the electronic message reception unit 24 transmits the frame rate information to the frame breakpoint estimation unit 22.

After receiving the frame rate information, the frame breakpoint estimation unit 22 calculates an upper limit Dmax of a breakpoint of a video frame by setting a received value of the frame rate as a frame rate f (Step S22). The upper limit Dmax of the breakpoint of the video frame is set as a reference value, based on which a breakpoint of a video frame is determined, when a predetermined time or more elapses from a reception time of a leading packet of the video frame. The frame breakpoint estimation unit 22 determines a breakpoint of a video frame, when an elapsed time from a reception time of a leading packet at a packet reception time has exceeded the upper limit Dmax. The upper limit Dmax of the breakpoint of the video frame is set as Dmax=β/f. β denotes a sensitivity coefficient, and is set in advance.

The NIC 26 of the reception device 20 receives a packet addressed to an own device, which is transmitted via the communication network 50, and transmits the received packet to the VMS unit 25 (Step S23). The VMS unit 25 decodes the compression-encoded video frame, based on data of the received packet, and generates video frame data. After generating the video frame data, the VMS unit 25 transmits the video frame data to a display device and the like.

When the NIC 26 transmits the received packet to the VMS unit 25, the NIC monitoring unit 21 monitors the packet received by the NIC 26, and extracts packet information. The packet information on the video frame includes a reception time of the packet, a transport protocol, a transmission source IP address, a transmission source port number, a transmission destination IP address, a transmission destination port number, a payload size, and the like. Although a packet other than a video frame flows through the NIC 26 of the reception device 20, it is possible to extract only the packet of the video frame by performing filtering, based on a transmission source IP address and a transmission destination port number.

When the packet of the video frame is extracted by the NIC monitoring unit 21, the frame breakpoint estimation unit 22 calculates a reception interval I(t) of packets. It is assumed that a t-th packet extracted by the NIC monitoring unit 21 is a packet P(t), a reception time of the packet P(t) is p(t), and a data size of the packet P(t) is s(t). At this occasion, the frame breakpoint estimation unit 22 calculates the reception interval I(t) of the packet P(t) and a packet P(t−1), as I(t)=p(t)−p(t−1) (Step S24). Further, the frame breakpoint estimation unit 22 holds a sum of data sizes from a leading packet to the packet P(t) of one video frame, as S bytes. The initial value is S=0.

After calculating the reception interval I(t), based on packet information on the packet P(t−1) and the packet P(t), the frame breakpoint estimation unit 22 tests the reception interval I(t), and estimates whether the packet P(t) is a packet being a breakpoint of the video frame. The frame breakpoint estimation unit 22 tests the reception interval I(t) by assuming that a test condition is a percentages, a rejection threshold value is X seconds, a null hypothesis is “the packet P(t) is not a breakpoint position of a video frame”, and an alternative hypothesis is “the packet P(t) is a breakpoint position of a video frame”.

A reception interval X at a confidence interval α being a test condition is set in advance by transmission and reception of test data and the like. The reception interval X is set by generating a cumulative distribution function (CDF) of a reception interval of packets, when test data are transmitted and received, and acquiring the reception interval X of packets at the confidence interval α. The reception interval X is set not by discontinuous data transmission like live video distribution but by measuring a reception interval in continuous transmission during which burst transfer is performed. The CDF is set for each network environment in use. The confidence interval α is a threshold value that is set in advance, and is set, for example, as α−95 percentages.

When the reception interval I(t) is more than a threshold value (Yes in Step S25), the frame breakpoint estimation unit 22 determines that the packet P(t) is a packet being a breakpoint of the video frame (Step S27).

When the reception interval I(t) is equal to or less than the threshold value X(t) (No in Step S25), the frame breakpoint estimation unit 22 compares the elapsed time from the reception time of the leading packet of the video frame with the upper limit Dmax. When it is assumed that the reception time of the packet, which is determined to be a breakpoint of the video frame at a previous time is d, the frame breakpoint estimation unit 22 determines that the packet P(t) is a packet being a breakpoint of the video frame also when p(t)−d≥Dmax is satisfied (Step S27).

In Step S27, when the frame breakpoint estimation unit 22 determines that the packet P(t) is a breakpoint of the video frame, the frame breakpoint estimation unit 22 regards the packet P(t−1) as the trailing packet of the video frame, and the packet P(t) as the leading packet of a next video frame. When at least either I(t)>X or p(t)−d≥Dmax is satisfied, the frame breakpoint estimation unit 22 determines a position between the packet P(t−1) and the packet P(t) as a breakpoint of the video frame. Specifically, assuming that I(t)>X is a first condition, and p(t)−d≥Dmax is a second condition, when at least either the first condition or the second condition is satisfied, the frame breakpoint estimation unit 22 determines that the position is a breakpoint of the video frame.

After detecting a breakpoint position of the video frame, the frame breakpoint estimation unit 22 updates the value of the time d as d=p(t), and initializes the sum S of data sizes of video frames as S=0. After updating the time d and the sum S of data sizes, the frame breakpoint estimation unit 22 transmits, to the feedback transmission unit 23, information relating to a reception duration of the packet, and information on a data size of the video frame.

When a packet being a breakpoint of the video frame is detected, and a breakpoint between the i-th video frame and the (i+1)-th video frame is detected, the frame breakpoint estimation unit 22 sets the value of S as a data size of the i-th video frame. The frame breakpoint estimation unit 22 transmits, to the feedback transmission unit 23, information on a reception completion time of the i-th video frame, a reception start time of the (i+1)-th video frame, and the data size of the i-th video frame, as feedback information. After receiving the feedback information, the feedback transmission unit 23 transmits the received feedback information to the transmission device 10 via the communication network 50 (Step S29).

When further receiving a packet of the video frame during transmission of the feedback information (Yes in Step S30), the frame breakpoint estimation unit 22 and the like of the reception device 20 repeats an operation from Step S24. When not receiving a packet of the video frame during transmission of the feedback information (No in Step S30), the reception device 20 waits until receiving a packet.

When p(t)-max is not satisfied in Step S26, the frame breakpoint estimation unit 22 determines that the packet P(t) is not a packet being a breakpoint of the video frame (Step S31). When it is determined that the packet P(t) is not a packet being a breakpoint of the video frame, the frame breakpoint estimation unit 22 updates the sum S of data sizes as S=S+s(t) (Step S32) When the frame breakpoint estimation unit 22 updates the sum S of data sizes, an operation from Step S23 is repeated.

When information indicating a reception time and a data size of the video frame is transmitted to the transmission device 10 via the communication network 50 as feedback information, the feedback reception unit 14 of the transmission device 10 receives the feedback information (Step S13). After receiving the feedback information, the feedback reception unit 14 transmits the received feedback information to the throughput measurement unit 15.

After receiving the feedback information the throughput measurement unit 15 holds the received feedback information, and calculates throughput (Step S14). The throughput measurement unit 15 calculates the throughput, as a statistical amount, based on feedback information corresponding to a predetermined number of video frames.

After calculating the throughput, the throughput measurement unit 15 transmits the calculated throughput to the parameter determination unit 11. After receiving the throughput, the parameter determination unit 11 determines a frame rate, based on the received throughput (Step S15), The throughput measurement unit 15 holds in advance a data table indicating a relationship between throughput and a frame rate. The throughput measurement unit 15 may determine a frame rate, based on a calculation formula set based on a value of throughput. When the frame rate is determined, the throughput measurement unit 15 transmits information on the determined frame rate to the compression encoding unit 12 and the electronic message transmission unit 16.

After receiving the frame rate information, the electronic message transmission unit 16 transmits, to the reception device 20, the received throughput information, as a compression encoding parameter (Step S16). When video frame data to be transmitted are present during transmission of a frame rate to the reception device 20 by the electronic message transmission unit 16 (Yes in Step S17), the transmission device 10 repeats an operation from Step S12. When video frame data to be transmitted are not present (No in Step S17), the transmission device 10 waits until video frame data are input next time.

The video distribution system according to the present example embodiment is a system for performing distribution of live video such as video captured by a camera and the like. In live video distribution, data transmission is intermittently performed in a unit of a video frame to which compression encoding is applied. Therefore, for estimation of throughput, information on a reception start time, a reception completion time, and a data size of a received video frame for each received video frame is necessary.

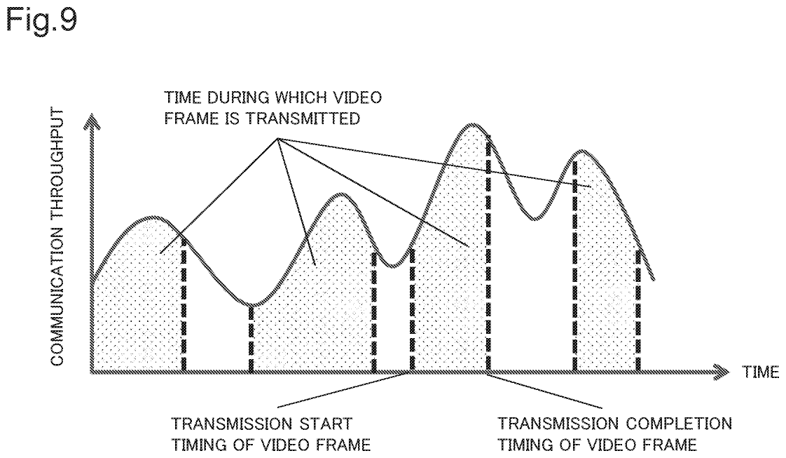

As illustrated in FIG. 9, in the video distribution system according to the present example embodiment, unlike a case that accumulated pieces of data are transmitted altogether, video frame data are transmitted at a timing when compression encoding of a video frame that is captured on a real-time basis is completed, and transmission is enabled. Therefore, a non-transmission time during which data transmission is not performed is present. In view of the above, in a video distribution system for performing live video distribution, in estimating throughput, not arithmetic averaging in which a data size received per unit time is divided by a unit time, but calculation by using a data size in the unit of each video frame and a time required for receiving a video frame is necessary. Therefore, in the video distribution system for performing live video distribution, a reception start time and a reception completion time for each received video frame are necessary.

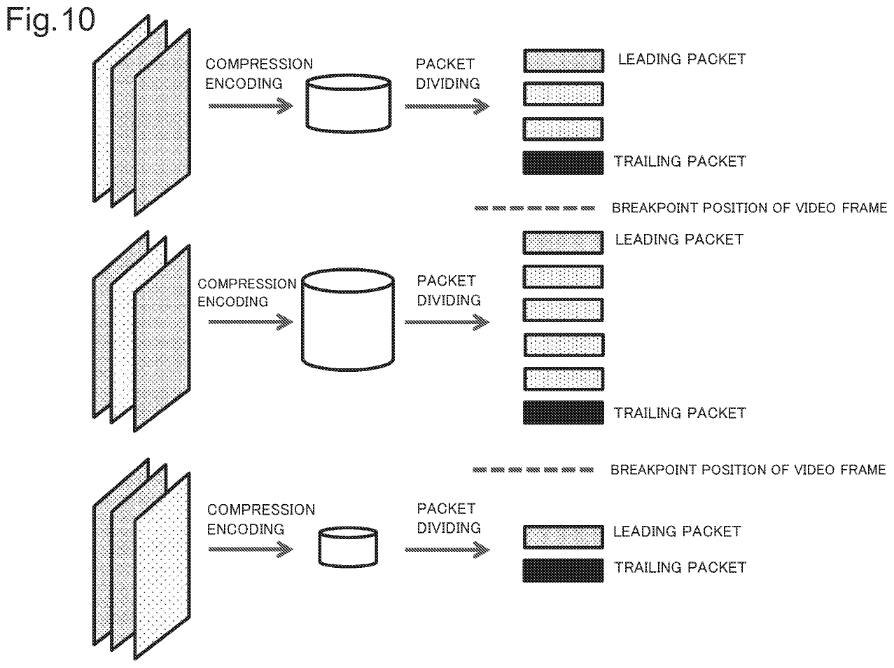

As illustrated in FIG. 10, video frame data are transmitted by being divided into packets after compression encoding. FIG. 10 is a diagram schematically illustrating packets acquired by dividing a video frame. Since video frame data are transmitted by being divided into packets after compression encoding, in order to acquire information on a reception start time and a reception completion time for each video frame, it is necessary to acquire information on a reception time of a trailing packet of a video frame, and a reception time of a leading packet of a next video frame.

In the video distribution system according to the present example embodiment, the frame breakpoint estimation unit 22 of the reception device 20 determines a breakpoint of a video frame, and transmits, to the transmission device 10, information on a reception time of a trailing packet of a video frame, a reception time of a leading packet of a next video frame, and a data size. Thus, since the transmission device 10 can acquire information on a reception start time, a reception completion time, and a data size of a video frame for each received video frame, it is possible to calculate throughput in a video distribution system for performing live video distribution. Further, since throughput is calculated as a statistical amount, even when a packet that is determined to be a packet at a breakpoint position of a video frame, and a packet at an actual breakpoint position are displaced from each other, it is possible to acquire information on a reception duration and a data size of a video frame by suppressing an influence by displacement.

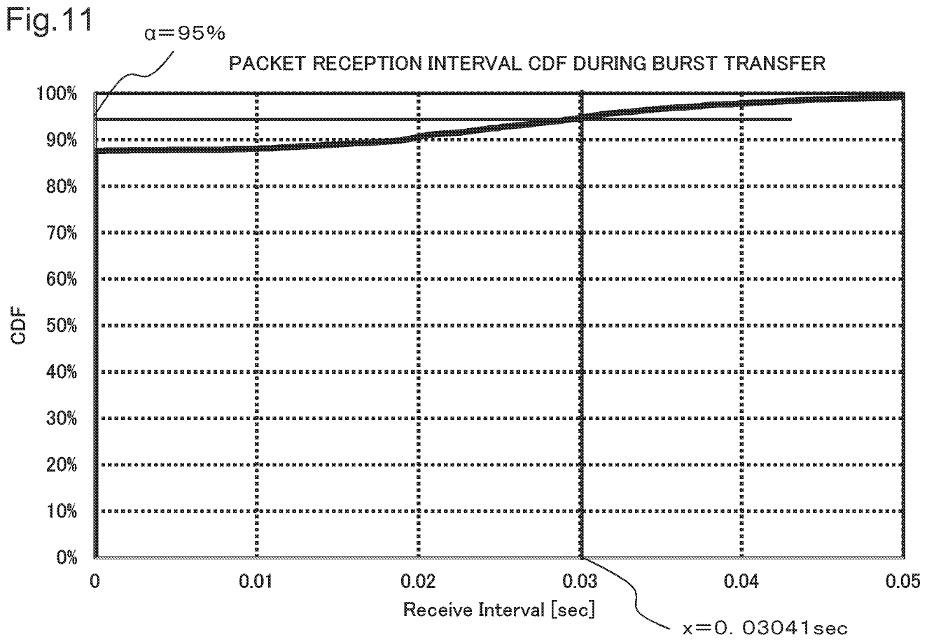

A more specific example of the video distribution system according to the present example embodiment is described. It is assumed that a CDF of a reception interval of packets, which is measured by performing in advance burst transfer of data in a network environment in use is as illustrated in FIG. 11. FIG. 11 is a diagram illustrating a measurement result of a reception interval of packets, which is measured by performing in advance burst transfer of data in a network environment in use. In the example of FIG. 11, when it is assumed that a confidence interval α is α=95 percentages as a test condition, the threshold value X of test rejection is X=0.03041 sec. It is assumed that the sensitivity coefficient β is β=1.0, and the frame rate f to be received from a transmission device is f=10 frames per second (fps). At this occasion, the upper limit Dmax of a breakpoint of a video frame becomes Dmax=β/f=0.1 sec.

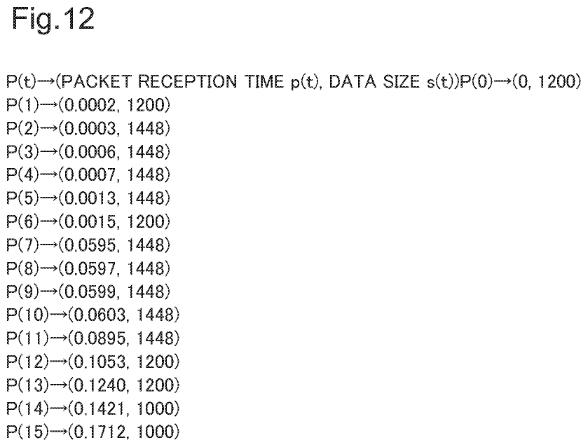

It is assumed that the NIC monitoring unit 21 of the reception device 20 successively receives the packet P(t) of a video frame having the data size s(t) at the reception time p(t) as illustrated in FIG. 12. FIG. 12 illustrates an example of data in which the packet p(t) has the reception time p(t) and the data size s(t).

After receiving information on a packet P(0), the frame breakpoint estimation unit 22 stores information in which d=p(0) and S=1200, as an initial state. Next, after receiving information on a packet P(1), the frame breakpoint estimation unit 22 calculates the reception interval I(1)=p(1)−P(0)=0.0002 sec., and compares with a conditional expression, Since p(1)−d=0.0002, neither I(1)>X nor p(1)−d≥Dmax is satisfied. Therefore, the frame breakpoint estimation unit 22 determines that the packet P(1) is not a breakpoint of a video frame. When it is determined that the packet P(1) is not a breakpoint of a video frame, the frame breakpoint estimation unit 22 updates the sum S of data sizes as S=S+s(1)=2400 bytes. Likewise, since packets P(2), P(3), P(4), and P(5) do not satisfy the conditional expression, the frame breakpoint estimation unit 22 determines that the packets are not a breakpoint of a video frame. At this occasion, the sum S of data sizes becomes S=9392 bytes.

When a packet P(7) is received, I(7)=0.0580, and the condition: I(7)≥X is satisfied. Therefore, the frame breakpoint estimation unit 22 determines that there is a breakpoint of a video frame between the packet P(6) and the packet P(7). When it is determined that there is a breakpoint of a video frame between the packet P(6) and the packet P(7), the frame breakpoint estimation unit 22 determines that the packet P(6) is the trailing packet of the video frame, and the packet P(7) is the leading packet of the next video frame. When the trailing packet of the video frame and the leading packet of the next video frame are determined, the frame breakpoint estimation unit 22 transmits feedback information to the feedback transmission unit 23. At this occasion, the feedback information is constituted of data in which a reception start time of a video frame is p(0)=0, a reception completion time of the video frame is p(6)=0.0015 sec., and a data size of the video frame is S=9392 bytes. After receiving the feedback information, the feedback transmission unit 23 transmits the received feedback information to the transmission device 10.

When the frame breakpoint estimation unit 22 further receives information on packets P(8), P(9), P(10), P(11), P(12), P(13), and P(14) in this order, since the conditional expression is not satisfied, S=10640 bytes. When a packet P(15) is received, since I(15)=0.0291 sec., the condition: I(15)>X is not satisfied. However, p(15)−d=0.1117 sec., and the condition: p(15)−d≥Dmax is satisfied. Therefore, the frame breakpoint estimation unit 22 determines that there is a breakpoint before the packet P(15), the packet P(14) is the trailing packet of the video frame, and the packet P(15) is the leading packet of the next video frame. When the trailing packet of the video frame and the leading packet of the next video frame are determined, the frame breakpoint estimation unit 22 transmits feedback information to the feedback transmission unit 23. After receiving the feedback information, the feedback transmission unit 23 transmits the received feedback information to the transmission device 10, and the processing is successively repeated.

By testing a reception interval I(t) of packets measured as described above at the confidence interval α percentages from the packet reception interval CDF during burst transfer, the reception device 20 detects a peak of I(t). Even when a peak of I(t) does not occur, and is not detected for a long time, the reception device 20 can detect a peak as a breakpoint of a video frame at an appropriate interval, based on a frame interval to be calculated from a frame rate.

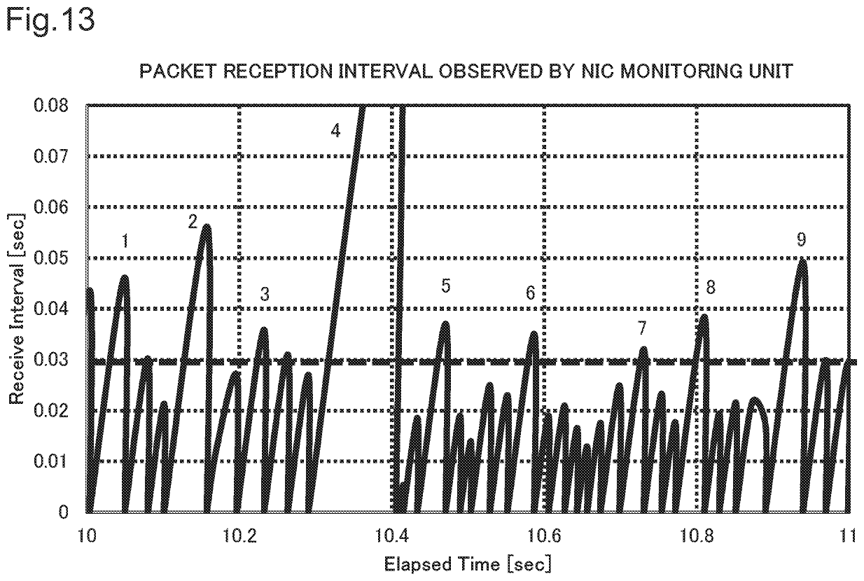

FIG. 13 is a graph illustrating a reception interval of packets in the NIC 26 of the reception device 20, when live video distribution is performed by setting the frame rate to 10 fps. When it is assumed that the threshold value X of test rejection is X=0.03041 sec., there are nine pieces of reception interval I(t) to be detected per second, and video frames approximate to ten frame rates per second are actually detected.

The video distribution system according to the present example embodiment determines a packet being a breakpoint of a frame in the frame breakpoint estimation unit 22 of the reception device 20. Further, the frame breakpoint estimation unit 22 transmits, to the transmission device 10 via the feedback transmission unit 23, information on a reception time of a trailing packet of a video frame preceding to a position, which is determined to be a breakpoint, and a reception time of a leading packet of a video frame succeeding to the video frame, and information on a data size. Thus, since the transmission device 10 can acquire information on a reception start time, a reception completion time, and a data size of a packet of a video frame, it is possible to calculate throughput, when a video frame is transmitted even during intermittent transmission. Further, by calculating throughput as described above, it is possible to calculate throughput, when the transmission device 10 transmits a video frame, based on information fed back from the reception device 20, without adding a function to the VMS, and perform setting of an appropriate compression encoding parameter. Consequently, the video distribution system according to the present example embodiment can precisely estimate throughput, based on a breakpoint of a video frame, when transmission is intermittently performed in a video frame unit.

By estimating throughput, based on a breakpoint of a video frame in the reception device 20, and feeding back to the transmission device 10, it is possible to dynamically set a compression encoding parameter according to the throughput. Therefore, the video distribution system according to the present example embodiment enables to perform high-quality video distribution without fluctuation according to throughput.

The second example embodiment describes only one reception device 20. Alternatively, a plurality of reception devices 20 may be provided. In such a configuration, throughput is calculated, and a frame rate is determined for each reception device 20, or for each group of reception devices 20 in which a communication path is the same.

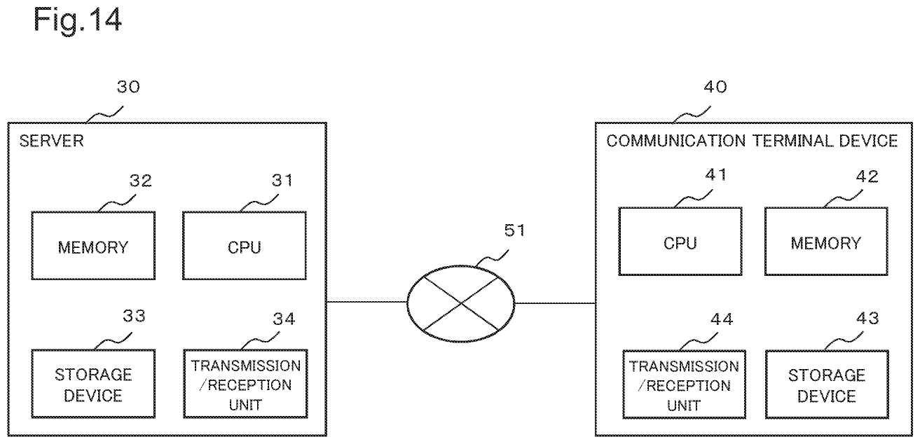

The video distribution system according to the second example embodiment may be configured as illustrated in FIG. 14. FIG. 14 illustrates an example of a configuration of the video distribution system according to the second example embodiment. The video distribution system in FIG. 14 includes a server 30 and a communication terminal device 40. The server 30 and the communication terminal device 40 are connected via a communication network 51. The server 30 corresponds to the transmission device 10 according to the second example embodiment. The communication terminal device 40 corresponds to the reception device 20 according to the second example embodiment. The communication network 51 has a configuration similar to the communication network 50 according to the second example embodiment.

The server 30 in FIG. 14 includes a central processing unit (CPU) 31, a memory 32, a storage device 33, and a transmission/reception unit 34. The server 30 has a function as a video distribution server. The server 30 performs each processing of the transmission device 10 according to the second example embodiment by causing the CPU 31 to execute a computer program. The CPU 31 reads the computer program from the storage device 33, and executes the computer program. The CPU 31 holds data in the memory 32, when executing the computer program, and holds a processing result in the storage device 33. The server 30 transmits a frame rate and a packet of a video frame to the communication terminal device 40 via the transmission/reception unit 34. The server 30 receives feedback information from the communication terminal device 40 via the transmission/reception unit 34.

The communication terminal device 40 in FIG. 14 includes a CPU 41, a memory 42, a storage device 43, and a transmission/reception unit 44. The communication terminal device 40 has a function of receiving a video frame, and outputting the video frame as a video signal. A smartphone, a tablet computer, and the like may be employed as the communication terminal device 40. The communication terminal device 40 performs each processing in the reception device 20 according to the second example embodiment by causing the CPU 41 to execute a computer program. The CPU 41 reads the computer program from the storage device 43, and executes the computer program. The CPU 41 holds data in the memory 42, when executing the computer program, and holds a processing result in the storage device 43. The communication terminal device 40 receives, from the transmission/reception unit 44, frame rate information and a packet of a video frame, which are transmitted from the server 30. Further, the communication terminal device 40 transmits feedback information to the server 30 via the transmission/reception unit 44.

A program to be executed in a transmission device and a reception device may be stored in a recording medium, and distributed. As the recording medium, for example, it is possible to use a magnetic tape for data recording, or a magnetic disk such as a hard disk. As the recording medium, it is also possible to use an optical disc such as a compact disc read only memory (CD-ROM) and a digital versatile disc (DVD), or a magneto optical disk (MO). A semiconductor memory may be used as the recording medium.

A part or all of the above-described example embodiments may be described as the following supplementary notes, but are not limited to the following.

### [Supplementary Note 1]

A reception device including:
a reception means for receiving a packet acquired by dividing a video frame:

a breakpoint position estimation means for estimating, based on packet information on the packet received by the reception means, a packet being a breakpoint between the video frames; and
a transmission means for transmitting, to a transmission device of the packet, information relating to a reception duration of the video frame and information on a data size, based on a result of estimation of a breakpoint position.

### [Supplementary Note 2]

The reception device according to supplementary note 1, wherein
the breakpoint position estimation means integrates a data size of the packet received by the reception means during a period from determination of a packet being a breakpoint of the video frame until determination of a packet being a next breakpoint, and sets an integrated value when a packet being a breakpoint is determined, as a data size of the video frame.

### [Supplementary Note 3]

The reception device according to supplementary note 1 or 2, wherein
the breakpoint position estimation means determines, when the packet received by the reception means satisfies at least one of a first condition being set based on a reception interval of the packet, and a second condition being set based on a frame rate of the video frame, that the packet received by the reception means is a packet being a breakpoint of the video frame.

### [Supplementary Note 4]

The reception device according to supplementary note 3, further including
an electronic message reception means for receiving, from a transmission device of the video frame, information on the frame rate, as an electronic message, wherein
the breakpoint position estimation means determines whether the packet received by the reception means satisfies the second condition being set based on the frame rate to be received by the electronic message reception means as the electronic message.

### [Supplementary Note 5]

The reception device according to supplementary note 3 or 4, wherein
the first condition is set as a threshold value being set based on a reception interval measured by performing burst transfer of a plurality of packets, and,
when a reception interval of the packet received by the reception means exceeds the threshold value, the breakpoint position estimation means determines that the first condition is satisfied.

### [Supplementary Note 6]

The reception device according to any one of supplementary notes 1 to 5, wherein
the transmission means transmits, to the transmission device, a reception time of a leading packet, and a reception time of a trailing packet of the video frame of which a breakpoint position is estimated, as information relating to a reception duration of the video frame.

### [Supplementary Note 7]

A transmission device including:
a reception means for receiving, from a reception device, information on a time required for receiving a video frame and a data size of the video frame in the reception device being a transmission destination of the video frame;
a throughput measurement means for calculating transmission and reception throughput of the video frame, as statistical data, based on information relating to a time required for receiving the video frame and a data size of the video frame in the reception device;
a parameter determination means for determining, based on the statistical data of the throughput, a parameter when the video frame to be transmitted to the reception device is compression-encoded;
a compression encoding means for applying compression encoding to the video frame, based on the parameter determined by the parameter determination means; and
a transmission means for transmitting, to the reception device, a packet based on data of the video frame to which compression encoding is applied by the compression encoding means.

### [Supplementary Note 8]

The transmission device according to supplementary note 7, further including
an electronic message transmission means for transmitting; to the reception device being a transmission destination of the video frame to which compression encoding is applied based on the parameter, information on the parameter determined by the parameter determination means, as an electronic message.

### [Supplementary Note 9]

The transmission device according to supplementary note 7 or 8, wherein
a time required for receiving a video frame in the reception device is constituted based on a reception duration of a leading packet, and a reception duration of a trailing packet of a video frame which is determined by estimating a breakpoint of a video frame by the reception device.

### [Supplementary Note 10]

A video distribution system including:
the transmission device according to any one of supplementary notes 7 to 9; and
the reception device according to any one of supplementary notes 1 to 6, wherein
the reception device receives a packet based on a video frame, from the transmission device via a communication network,
the breakpoint position estimation means of the reception device estimates a packet being a breakpoint between the video frames, based on packet information on the packet received from the transmission device, and
the throughput measurement means of the transmission device calculates, based on a time required for receiving a video frame to be received from the reception device and a data size of the video frame, transmission and reception throughput of a video frame, as statistical data.

### [Supplementary Note 11]

A video distribution method including:
receiving a packet acquired by dividing a video frame;
estimating, based on packet information on the received packet, a packet being a breakpoint between the video frames; and
transmitting, to a transmission device of the packet, information relating to a reception duration of the video frame and information on a data size, based on a result of estimation of a breakpoint position.

### [Supplementary Note 12]

The video distribution method according to supplementary note 11, further including
integrating a data size of the received packet during a period from determination of a packet being a breakpoint of the video frame until determination of a packet being a next breakpoint, and setting an integrated value when a packet being a breakpoint is determined, as a data size of the video frame.

### [Supplementary Note 13]

The video distribution method according to supplementary note 11 or 12, further including
determining, when the received packet satisfies at least one of a first condition being set based on a reception interval of the packet, and a second condition being set based on a frame rate of the video frame, that the received packet is a packet being a breakpoint of the video frame.
   [Supplementary note 14]

The video distribution method according to supplementary note 13, further including:
receiving information on the frame rate, from a transmission device of the video frame, as an electronic message; and
determining whether the received packet satisfies the second condition being set based on the frame rate to be received as the electronic message.

### [Supplementary Note 15]

The video distribution method according to supplementary note 13 or 14, further including:
setting the first condition as a threshold value being set based on a reception interval measured by performing burst transfer of a plurality of packets; and,
when a reception interval of the received packet exceeds the threshold value, determining that the first condition is satisfied.

### [Supplementary Note 16]

The video distribution method according to any one of supplementary notes 11 to 15, further including
transmitting, to the transmission device, a reception time of a leading packet, and a reception time of a trailing packet of the video frame of which a breakpoint position is estimated, as information relating to a reception duration of the video frame.
   [Supplementary note 17]

The video distribution method according to any one of supplementary notes 11 to 16, further including:
receiving, from a reception device, information relating to a time required for receiving a video frame and information on a data size of the video frame in the reception device being a transmission destination of the video frame;
calculating transmission and reception throughput of the video frame, as statistical data, based on a time required for receiving the video frame and a data size of the video frame in the reception device;
determining, based on the statistical data of the throughput, a parameter when the video frame to be transmitted to the reception device is compression-encoded;
applying compression encoding to the video frame, based on the determined parameter; and
transmitting, to the reception device, a packet based on data of the video frame to which compression encoding is applied.

### [Supplementary Note 18]

A video distribution method including:
receiving, from a reception device, information relating to a time required for receiving a video frame and information on a data size of the video frame in the reception device being a transmission destination of the video frame;
calculating transmission and reception throughput of the video frame, as statistical data, based on a time required for receiving the video frame and a data size of the video frame in the reception device;
determining, based on the statistical data of the throughput, a parameter when the video frame to be transmitted to the reception device is compression-encoded;
applying compression encoding to the video frame, based on the determined parameter; and
transmitting, to the reception device, a packet based on data of the video frame to which compression encoding is applied.

### [Supplementary Note 19]

The video distribution method according to supplementary note 17 or 18, further including
transmitting, to the reception device being a transmission destination of the video frame to which compression encoding is applied based on the parameter, information on the determined parameter, as an electronic message.

### [Supplementary Note 20]

The video distribution method according to any one of supplementary notes 17 to 19, further including
constituting a time required for receiving a video frame in the reception device, based on a reception duration of a leading packet, and a reception duration of a trailing packet of a video frame which is determined by estimating a breakpoint of a video frame by the reception device.

### [Supplementary Note 21]

A video reception program causing a computer to execute:
processing of receiving a packet acquired by dividing a video frame;
processing of estimating, based on packet information on the received packet, a packet being a breakpoint between the video frames: and
processing of transmitting, to a transmission device of the packet, information relating to a reception duration of the video frame of which a breakpoint position is estimated and information on a data size.

### [Supplementary Note 22]

The video reception program according to supplementary note 21, further including
integrating a data size of the received packet during a period from determination of a packet being a breakpoint of the video frame until determination of a packet being a next breakpoint, and setting an integrated value when a packet being a breakpoint is determined, as a data size of the video frame.

### [Supplementary Note 23]

The video reception program according to supplementary note 21 or 22, further including,
when the received packet satisfies at least one of a first condition being set based on a reception interval of the packet, and a second condition being set based on a frame rate of the video frame, determining that the received packet is a packet being a breakpoint of the video frame.

### [Supplementary Note 24]

The video reception program according to supplementary note 23, further including:
receiving information on the frame rate, from a transmission device of the video frame, as an electronic message; and
determining whether the received packet satisfies the second condition being set based on the frame rate to be received as the electronic message.

### [Supplementary Note 25]

The video reception program according to supplementary note 23 or 24, further including:
setting the first condition as a threshold value being set based on a reception interval measured by performing burst transfer of a plurality of packets; and,
when a reception interval of the received packet exceeds the threshold value, determining that the first condition is satisfied.

### [Supplementary Note 26]

The video reception program according to any one of supplementary notes 21 to 25, further including
transmitting, to the transmission device, a reception time of a leading packet, and a reception time of a trailing packet of the video frame of which a breakpoint position is estimated, as information relating to a reception duration of the video frame.

### [Supplementary Note 27]

A video transmission program causing a computer to execute:
processing of receiving, from a reception device, information on a time required for receiving a video frame and a data size of the video frame in the reception device being a transmission destination of the video frame;
processing of calculating transmission and reception throughput of the video frame, as statistical data, based on information relating to a time required for receiving the video frame and a data size of the video frame in the reception device;
processing of determining, based on the statistical data of the throughput, a parameter when the video frame to be transmitted to the reception device is compression-encoded;
processing of applying compression encoding to the video frame, based on the determined parameter; and
processing of transmitting, to the reception device, a packet based on data of the video frame to which compression encoding is applied.

### [Supplementary Note 28]

The video transmission program according to supplementary note 27, further including
enabling processing of transmitting, to the reception device being a transmission destination of the video frame to which compression encoding is applied based on the parameter, information on the determined parameter, as an electronic message.

### [Supplementary Note 29]

The video transmission program according to supplementary note 27 or 28, further including
constituting a time required for receiving a video frame in the reception device, based on a reception duration of a leading packet, and a reception duration of a trailing packet of a video frame which is determined by estimating a breakpoint of a video frame by the reception device.

While the invention has been particularly shown and described with reference to exemplary embodiments thereof, the invention is not limited to these embodiments. It will be understood by those of ordinary skill in the art that various changes in form and details may be made therein without departing from the spirt and scope of the present invention as defined by the claims.

This application is based upon and claims the benefit of priority from Japanese patent application No. 2017-206266, filed on Oct. 25, 2017, the disclosure of which is incorporated herein in its entirety by reference.

### REFERENCE SIGNS LIST

10 Transmission device
11 Parameter determination unit
12 Compression encoding unit
13 Video transmission unit
14 Feedback reception unit
15 Throughput measurement unit
16 Electronic message transmission unit
20 Reception device
21 NIC monitoring unit
22 Frame breakpoint estimation unit
23 Feedback transmission unit
24 Electronic message reception unit
25 VMS unit
26 NIC
30 Server
31 CPU
32 Memory
33 Storage device
34 Transmission/reception unit
40 Communication terminal device
41 CPU
42 Memory
43 Storage device
44 Transmission/reception unit
50 Communication network
100 Transmission device
101 Reception means
102 Throughput measurement means
103 Parameter determination means
104 Compression encoding means
105 Transmission means
200 Reception device
201 Reception means
202 Breakpoint position estimation means
203 Transmission means

1. A reception device comprising:
a receiver receiving a packet acquired by dividing a video frame;
a breakpoint position estimator estimating, based on packet information on the packet received by the receiver, a packet being a breakpoint between the video frames; and
a transmitter transmitting, to a transmission device of the packet, information relating to a reception duration of the video frame and information on a data size, based on a result of estimation of a breakpoint position.

2. The reception device according to claim 1, wherein
the breakpoint position estimator integrates a data size of the packet received by the receiver during a period from determination of a packet being a breakpoint of the video frame until determination of a packet being a next breakpoint, and sets an integrated value when a packet being a breakpoint is determined, as a data size of the video frame.

3. The reception device according to claim 1, wherein
the breakpoint position estimator determines, when the packet received by the receiver satisfies at least one of a first condition being set based on a reception interval of the packet, and a second condition being set based on a frame rate of the video frame, that the packet received by the receiver is a packet being a breakpoint of the video frame.

4. The reception device according to claim 3, further comprising
an electronic message receiver receiving, from a transmission device of the video frame, information on the frame rate, as an electronic message, wherein
the breakpoint position estimator determines whether the packet received by the receiver satisfies the second condition being set based on the frame rate to be received by the electronic message receiver as the electronic message.

5. The reception device according to claim 3, wherein the first condition is set as a threshold value being set based on a reception interval measured by performing burst transfer of a plurality of packets, and,
when a reception interval of the packet received by the receiver exceeds the threshold value, the breakpoint position estimator determines that the first condition is satisfied.

6. The reception device according to claim 1, wherein
the transmitter transmits, to the transmission device, a reception time of a leading packet, and a reception time of a trailing packet of the video frame of which a breakpoint position is estimated, as information relating to a reception duration of the video frame.

7. A transmission device comprising:
a receiver receiving, from a reception device, information on a time required for receiving a video frame and a data size of the video frame in the reception device being a transmission destination of the video frame;
a throughput measurer calculating transmission and reception throughput of the video frame, as statistical data, based on information relating to a time required for receiving the video frame and a data size of the video frame in the reception device;
a parameter determiner determining, based on the statistical data of the throughput, a parameter when the video frame to be transmitted to the reception device is compression-encoded;
a compression encoder applying compression encoding to the video frame, based on the parameter determined by the parameter determiner; and
a transmitter transmitting, to the reception device, a packet based on data of the video frame to which compression encoding is applied by the compression encoder.

8. The transmission device according to claim 7, further comprising
an electronic message transmitter transmitting, to the reception device being a transmission destination of the video frame to which compression encoding is applied based on the parameter, information on the parameter determined by the parameter determiner, as an electronic message.

9. The transmission device according to claim 7, wherein
a time required for receiving a video frame in the reception device is constituted based on a reception duration of a leading packet, and a reception duration of a trailing packet of a video frame which is determined by estimating a breakpoint of a video frame by the reception device.

10. (canceled)

11. A video distribution method comprising:
receiving a packet acquired by dividing a video frame;
estimating, based on packet information on the received packet, a packet being a breakpoint between the video frames; and
transmitting, to a transmission device of the packet, information relating to a reception duration of the video frame and information on a data size, based on a result of estimation of a breakpoint position.

12. The video distribution method according to claim 11, further comprising
integrating a data size of the received packet during a period from determination of a packet being a breakpoint of the video frame until determination of a packet being a next breakpoint, and setting an integrated value when a packet being a breakpoint is determined, as a data size of the video frame.

13. The video distribution method according to claim 11, further comprising
determining, when the received packet satisfies at least one of a first condition being set based on a reception interval of the packet, and a second condition being set based on a frame rate of the video frame, that the received packet is a packet being a breakpoint of the video frame.

14. The video distribution method according to claim 13, further comprising:
receiving information on the frame rate, from a transmission device of the video frame, as an electronic message; and
determining whether the received packet satisfies the second condition being set based on the frame rate to be received as the electronic message.

15. The video distribution method according to claim 13, further comprising
setting the first condition as a threshold value being set based on a reception interval measured by performing burst transfer of a plurality of packets; and,
when a reception interval of the received packet exceeds the threshold value, determining that the first condition is satisfied.

16. The video distribution method according to claim 11, further comprising
transmitting, to the transmission device, a reception time of a leading packet, and a reception time of a trailing packet of the video frame of which a breakpoint position is estimated, as information relating to a reception duration of the video frame.

17. The video distribution method according to claim 11, further comprising:
receiving, from a reception device, information relating to a time required for receiving a video frame and information on a data size of the video frame in the reception device being a transmission destination of the video frame; calculating transmission and reception throughput of the video frame, as statistical data, based on a time required for receiving the video frame and a data size of the video frame in the reception device;
determining, based on the statistical data of the throughput, a parameter when the video frame to be transmitted to the reception device is compression-encoded;
applying compression encoding to the video frame, based on the determined parameter; and
transmitting, to the reception device, a packet based on data of the video frame to which compression encoding is applied.

18. A video distribution method comprising:
receiving, from a reception device, information relating to a time required for receiving a video frame and information on a data size of the video frame in the reception device being a transmission destination of the video frame;
calculating transmission and reception throughput of the video frame, as statistical data, based on a time required for receiving the video frame and a data size of the video frame in the reception device;
determining, based on the statistical data of the throughput, a parameter when the video frame to be transmitted to the reception device is compression-encoded;
applying compression encoding to the video frame, based on the determined parameter; and
transmitting, to the reception device, a packet based on data of the video frame to which compression encoding is applied.

19. The video distribution method according to claim 17, further comprising
transmitting, to the reception device being a transmission destination of the video frame to which compression encoding is applied based on the parameter, information on the determined parameter, as an electronic message.

20. The video distribution method according to claim 17, further comprising
constituting a time required for receiving a video frame in the reception device, based on a reception duration of a leading packet, and a reception duration of a trailing packet of a video frame which is determined by estimating a breakpoint of a video frame by the reception device.

21.-29. (canceled)
